(19) United States
(12) Patent Application Publication
(10) Pub. No.: US 2008/0243894 A1
(43) Pub. Date: Oct. 2, 2008

(54) MEDICAL IMAGE FILE OUTPUT APPARATUS, MEDICAL IMAGE DIAGNOSTIC APPARATUS AND METHOD FOR OUTPUTTING MEDICAL IMAGE FILE

(76) Inventor: Shinichi Amemiya, Tokyo (JP)

Correspondence Address: PATRICK W. RASCHE (20459);ARMSTRONG TEASDALE LLP, ONE METROPOLITAN SQUARE, SUITE 2600, ST. LOUIS, MO, 63102-2740, US

(21) Appl. No.: 12/055,091

(22) Filed: Mar. 25, 2008

(30) Foreign Application Priority Data
Mar. 27, 2007 (JP) 2007-080466

(51) Int. Cl. G06F 17/30

(52) U.S. Cl. 707/101; 707/E17.009

(57) ABSTRACT

A medical image file output apparatus includes: a second-image input device which inputs a second image obtained by adding personal information in a human-readable manner to a first image obtained by scanning a subject; a third-image generating device which converts an area in the second image where the personal information is added, into a human-unreadable manner to generate a third image; and an image file output device which prepares an image file in a general image file format from the third image for output.

### CROSS REFERENCE TO RELATED APPLICATIONS

This application claims the benefit of Japanese Patent Application No. 2007-080466 filed Mar. 27, 2007, which is hereby incorporated by reference in its entirety.

### BACKGROUND OF THE INVENTION

The subject matter disclosed herein relates to a medical image file output apparatus and a medical image diagnostic apparatus, and more particularly to a medical image file output apparatus and a medical image diagnostic apparatus that can prevent leak of personal information.

There has been conventionally known a medical image storage system in which a medical image (for example, a cross-sectional image) is generated by scanning a subject, input personal information is encrypted and added to the medical image to generate a medical image with encrypted personal information, and the medical image with encrypted personal information is stored (see, for example, Japanese Unexamined Patent Publication No. 2006-167294).

In the conventional medical image storage system, even if the medical image with encrypted personal information is disclosed or flowed out, it is possible to prevent leak of personal information due to encryption of the personal information in the medical image.

However, each of image files output from most of existing medical image diagnostic apparatuses is a medical image with unencrypted personal information obtained by adding personal information in a human-readable manner to a medical image obtained by scanning a subject. Such an already-prepared medical image with unencrypted personal information involves a problem that can not be dealt with by the conventional medical image storage system. Further, the conventional medical image storage system involves a problem that it is impossible for an operator to immediately view the medical image with unencrypted personal information (an operator has to view beforehand a medical image with encrypted personal information).

### SUMMARY OF THE INVENTION

It is desirable that the problems described previously are solved.

In a first aspect, there is provided a medical image file output apparatus, including: a second-image input device which inputs a second image obtained by adding personal information in a human-readable manner to a first image obtained by scanning a subject; a third-image generating device which converts an area in the second image where the personal information is added, into a human-unreadable manner to generate a third image; and an image file output device which prepares an image file in a general image file format from the third image for output.

In the medical image file output apparatus according to the first aspect, when the second image (for example, already-prepared medical image with unencrypted personal information) is input, the area in the second image where the personal information is added is converted into a human-unreadable manner to generate the third image, and an image file in a general image file format is prepared from the third image for output. Since the image file is in a general image file format, it is possible even for anyone who does not have special software to easily view the medical image. In addition, since the area where the personal information is added is in a human-unreadable manner, it is possible to prevent leak of personal information.

In a second aspect, there is provided the medical image file output apparatus according to the first aspect, wherein the general image file format is any one of a JPEG format, a PIC format, and an acrobat format.

In the medical image file output apparatus according to the second aspect, since an image file in any one of a JPEG format, a PIC format, and an acrobat format is output, it is possible even for anyone who does not have special software to easily view the medical image.

In a third aspect, there is provided the medical image file output apparatus according to the first or second aspect, wherein the human-unreadable manner is a manner that can be reconverted into a human-readable manner.

In the medical image file output apparatus according to the third aspect, the area in the second image where the personal information is added is, for example, reversibly masked. Usage of software for unmasking allows for viewing the personal information.

In a fourth aspect, there is provided the medical image file output apparatus according to the third aspect, wherein the third-image generating device requires inputting of a user name and a password prior to generation of the third image.

In the medical image file output apparatus according to the fourth aspect, when the area in the second image where the personal information is added is, for example, reversibly masked, the area is masked in such a manner that the area can not be correctly unmasked without usage of the input user name and password. Thereby, it is possible to enhance the security.

In a fifth aspect, there is provided the medical image file output apparatus according to the first or second aspect, wherein the human-unreadable manner is a manner which can not be reconverted into a human-readable manner, the third-image generating device reads and encrypts the personal information in the second image to prepare an encrypted personal information file, and an encrypted personal information file output device for outputting the encrypted personal information file is further provided.

In the medical image file output apparatus according to the fifth aspect, since the area in the second image where the personal information is added is, for example, irreversibly masked, it is possible to completely prevent leak of personal information from the third image. It should be noted the personal information is output as a different encrypted file. Thus, the personal information is never lost.

In a sixth aspect, there is provided the medical image file output apparatus according to the fifth aspect, wherein the third-image generating device requires inputting of a user name and a password prior to generation of the encrypted personal information file.

In the medical image file output apparatus according to the sixth aspect, when the encrypted personal information file is generated, the personal information is encrypted in such a manner that the personal information can not be restored without usage of the input user name and password. Thereby, it is possible to enhance the security.

In a seventh aspect, there is provided the medical image file output apparatus according to any one of the first to sixth aspects, wherein the image file output device outputs the image file to a hard disk or a portable medium.

In the medical image file output apparatus according to the seventh aspect, the image file is output to, for example, a hard disk of a personal computer or a portable medium such as a portable hard disk. In the case where the image file brought out for a presentation of an academic conference is lost, the medical image is exposed to viewing. However, it is possible to prevent leak of personal information.

In an eighth aspect, there is provided a medical image diagnostic apparatus, including: a scanning device which scans a subject; first-image generating device which generates a first image from data obtained by scanning; a second-image generating device which generates a second image obtained by adding personal information in a human-readable manner to the first image; an image displaying device which displays the second image; a third-image generating device which converts an area in the second image where the personal information is added, into a human-unreadable manner to generate a third image; and an image file output device which prepares an image file in a general image file format from the third image for output.

In the medical image diagnostic apparatus according to the eighth aspect, it is possible to display the second image obtained by adding personal information in a human-readable manner to the first image obtained by scanning the subject. That is, an operator can immediately view the medical image with personal information in a human-readable manner (it is not necessary for an operator to view beforehand the medical image with personal information in a human-unreadable manner). On the other hand, since a file to be output is an image file in a general image file format prepared from the third image obtained by converting the area in the second image where the personal information is added, into a human-unreadable manner, it is possible even for anyone who does not have special software to easily view the medical image, and is possible to prevent leak of personal information.

In a ninth aspect, there is provided the medical image diagnostic apparatus according to the eighth aspect, wherein the general image file format is any one of a JPEG format, a PIC format, and an acrobat format.

In the medical image diagnostic apparatus according to the ninth aspect, since an image file in any one of a JPEG format, a PIC format, and an acrobat format is output, it is possible even for anyone who does not have special software to easily view the medical image.

In a tenth aspect, there is provided the medical image diagnostic apparatus according to the eighth or ninth aspect, wherein the human-unreadable manner is a manner that can be reconverted into a human-readable manner.

In the medical image diagnostic apparatus according to the tenth aspect, the area in the second image where the personal information is added is, for example, reversibly masked. Usage of software for unmasking allows for viewing the personal information.

In an eleventh aspect, there is provided the medical image diagnostic apparatus according to the tenth aspect, including: an image file input device which inputs the image file; and an image regenerating device which regenerates the third image from the image file and reconverts the area in the third image converted into the human-unreadable manner, into a human-readable manner to regenerate the second image.

In the medical image diagnostic apparatus according to the eleventh aspect, since the second image is regenerated from the image file, it is possible to view the personal information.

In a twelfth aspect, there is provided the medical image diagnostic apparatus according to the eleventh aspect, wherein the third-image generating device requires inputting of a user name and a password prior to generation of the third image, and the image regenerating device requires inputting of the user name and the password prior to regeneration of the second image.

In the medical image diagnostic apparatus according to the twelfth aspect, when the third image is generated, the second image is converted into the third image in such a manner that the second image can not be regenerated from the third image without usage of the input user name and password. In addition, when the second image is regenerated, inputting of the user name and the password is required. Since the second image can not be regenerated without usage of the input user name and password, it is possible to enhance the security.

In a thirteenth aspect, there is provided the medical image diagnostic apparatus according to the first or second aspect, wherein the human-unreadable manner is a manner which can not be reconverted into a human-readable manner, the third-image generating device reads and encrypts the personal information in the second image to prepare an encrypted personal information file, and an encrypted personal information file output device for outputting the encrypted personal information file is further provided.

In the medical image diagnostic apparatus according to the thirteenth aspect, since the area in the second image where the personal information is added is, for example, irreversibly masked, it is possible to completely prevent leak of personal information from the third image. It should be noted the personal information is output as a different encrypted file. Thus, the personal information is never lost.

In a fourteenth aspect, there is provided the medical image diagnostic apparatus according to the thirteenth aspect, including: an encrypted personal information file input device which inputs the encrypted personal information file; a personal information restoring device which restores the personal information from the encrypted personal information file; an image file input device which inputs the image file; and a personal information-restored image generating device which regenerates the third image from the image file and embeds the restored personal information into the area in the third image which is converted into the human-unreadable manner.

In the medical image diagnostic apparatus according to the fourteenth aspect, since the personal information is restored from the encrypted personal information file and the personal information-restored image is generated by adding the personal information to the third image which is regenerated from the image file, it is possible to view an image corresponding to the original second image.

In a fifteenth aspect, there is provided the medical image diagnostic apparatus according to the fourteenth aspect, wherein the third-image generating device requires inputting of a user name and a password prior to generation of the encrypted personal information file, and the personal information restoring device requires inputting of the user name and the password prior to restoration of the personal information.

In the medical image diagnostic apparatus according to the fifteenth aspect, when the encrypted personal information file is generated, the personal information is encrypted in such a manner that the personal information can not be restored without usage of the input user name and password. Thereby, it is possible to enhance the security. Further, if the user name and the password are input, the personal information can be restored.

In a sixteenth aspect, there is provided the medical image diagnostic apparatus according to the fourteenth aspect, wherein the third-image generating device requires inputting of a user name and a password prior to generation of the encrypted personal information file, and the personal information restoring device requires inputting of the user name and the password prior to embedding of the restored personal information.

In the medical image diagnostic apparatus according to the sixteenth aspect, when the encrypted personal information file is generated, the personal information-restored image is encrypted in such a manner that the personal information-restored image can not be generated without usage of the input user name and password. Thereby, it is possible to enhance the security. Further, if the user name and the password are input, the personal information-restored image can be generated.

In a seventeenth aspect, there is provided the medical image diagnostic apparatus according to any one of the eighth to sixteenth aspects, wherein the image file output device outputs the image file to a hard disk or a portable medium.

In the medical image diagnostic apparatus according to the seventeenth aspect, the image file is output to, for example, a hard disk of a personal computer or a portable medium such as a portable hard disk. In the case where the image file brought out for a presentation of an academic conference is lost, the medical image is exposed to viewing. However, it is possible to prevent leak of personal information.

According to a medical image file output apparatus of the invention, it is possible to output an image file prepared by preventing leak of personal information even for an already-prepared medical image (second image) with unencrypted personal information. In addition, according to a medical image diagnostic apparatus, an operator can immediately view the medical image (second image) with unencrypted personal information and an image file with leak of personal information prevented can be output.

The medical image file output apparatus and the medical image diagnostic apparatus of the invention prevent leak of personal information, and can be used for outputting a medical image file in a general image file format that is easily accessible to anyone.

Further objects and advantages of the present invention will be apparent from the following description of the preferred embodiments of the invention as illustrated in the accompanying drawings.

### BRIEF DESCRIPTION OF THE DRAWINGS

FIG. 1 is a diagram for explaining a configuration of an ultrasound diagnostic apparatus according to a first embodiment.

FIG. 2 is a flowchart showing procedures of a scanning process according to the first embodiment.

FIG. 3 is a flowchart showing an image file output process according to the first embodiment.

FIG. 4 is a flowchart showing an image file displaying process according to the first embodiment.

FIG. 5 is an exemplified view showing a first image obtained by scanning a subject.

FIG. 6 is an exemplified view showing a second image obtained by adding personal information to the first image.

FIG. 7 is an exemplified view showing a third image obtained by hiding the personal information in the second image.

FIG. 8 is a diagram for explaining a configuration of a medical image file output apparatus according to a second embodiment.

FIG. 9 is a flowchart showing an image file output process according to the second embodiment.

FIG. 10 is a diagram for explaining a configuration of an ultrasound diagnostic apparatus according to a third embodiment.

FIG. 11 is a flowchart showing an image file output process according to the third embodiment.

FIG. 12 is a flowchart showing an image file displaying process according to the third embodiment.

FIG. 13 is an exemplified view showing a third image obtained by deleting the personal information in the second image.

FIG. 14 is an exemplified view showing a personal information-restored image obtained by adding restored personal information.

FIG. 15 is a diagram for explaining a configuration of a medical image file output apparatus according to a fourth embodiment.

FIG. 16 is a flowchart showing an image file output process according to the fourth embodiment.

### DETAILED DESCRIPTION OF THE INVENTION

Hereinafter, the invention will be described in more detail based on embodiments as shown in the drawings. It should be noted that the invention is not limited to the embodiments.

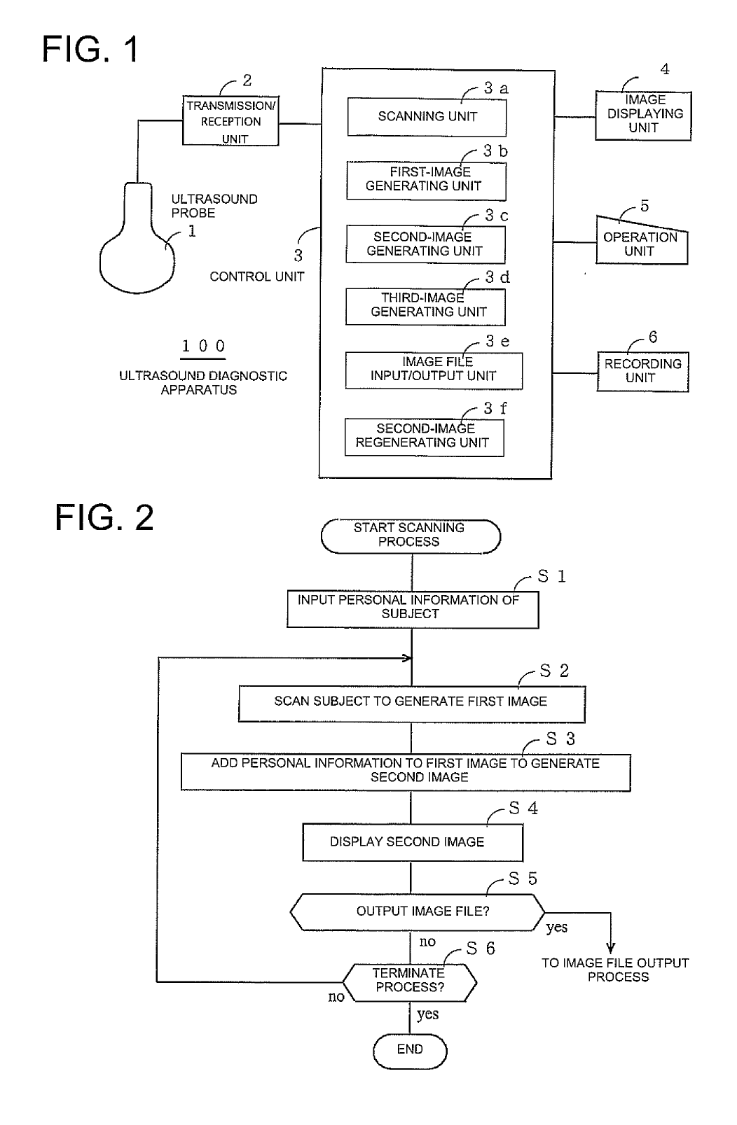

FIG. 1 is a diagram for explaining a configuration of an ultrasound diagnostic apparatus 100 according to a first embodiment.

The ultrasound diagnostic apparatus 100 includes an ultrasound probe 1, a transmission/reception unit 2 which drives the ultrasound probe 1 to scan the inside of a subject with an ultrasound beam, a control unit 3, an image displaying unit 4 which displays a second image to be described later, and the like, an operation unit 5 with which an operator inputs personal information or an instruction, and a recording unit 6 which records or reads an image file to be described later on/from a hard disk or a portable medium.

The control unit 3 includes a scanning unit 3a which controls scanning, a first-image generating unit 3b which generates a first image from data obtained by scanning, a second-image generating unit 3c which generates a second image obtained by adding personal information in a human-readable manner to the first image, a third-image generating unit 3d which generates a third image obtained by converting an area in the second image where the personal information is added, into a human-unreadable manner, an image file input/output unit 3e which converts the third image into an image file in a general image file format for output or input to/from the recording unit 6, and a second-image regenerating unit 3f which regenerates the third image from the input image file and reconverts the area in the third image converted into a human-unreadable manner, into a human-readable manner to regenerate the second image.

FIG. 2 is a flowchart showing procedures of a scanning process performed by the ultrasound diagnostic apparatus 100.

The scanning process is started by an instruction of an operator.

In Step S1, the operator inputs personal information (name, age, address and the like of a patient) of a subject with the operation unit 5, or selects already-input personal information.

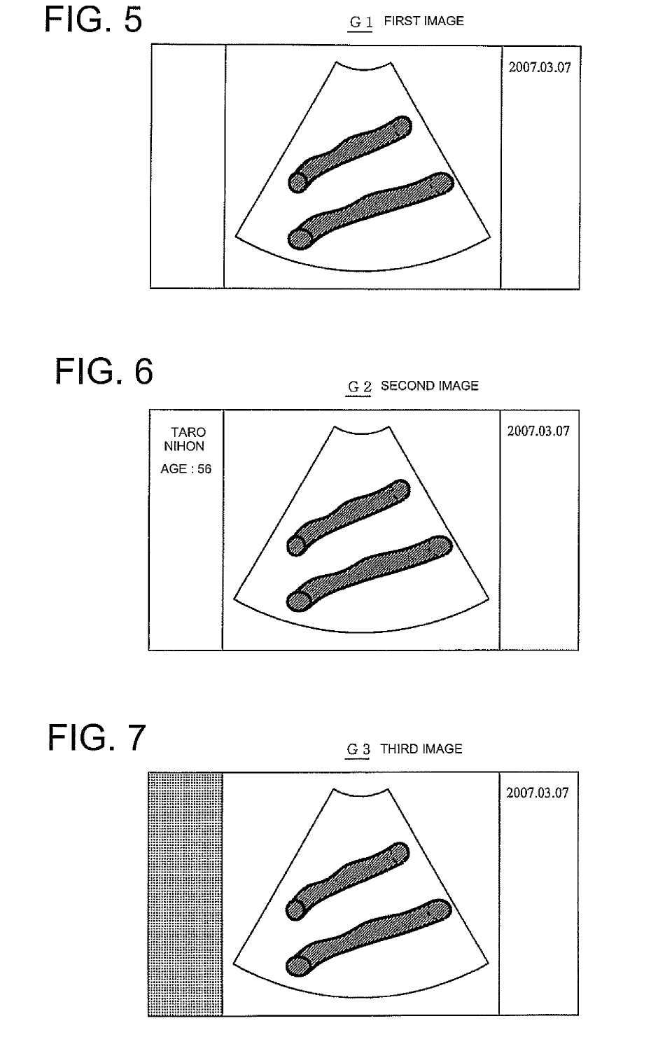

In Step S2, the subject is scanned by using the ultrasound probe 1, the transmission/reception unit 2, and the scanning unit 3a, and the first-image generating unit 3b generates a first image G1 as shown in FIG. 5.

In Step S3, the second-image generating unit 3c adds personal information in a human-readable manner to the first image G1 to generate a second image G2 as shown in FIG. 6.

In Step S4, the image displaying unit 4 displays the second image G2. The operator can make a diagnosis by viewing the second image G2 displayed in real time.

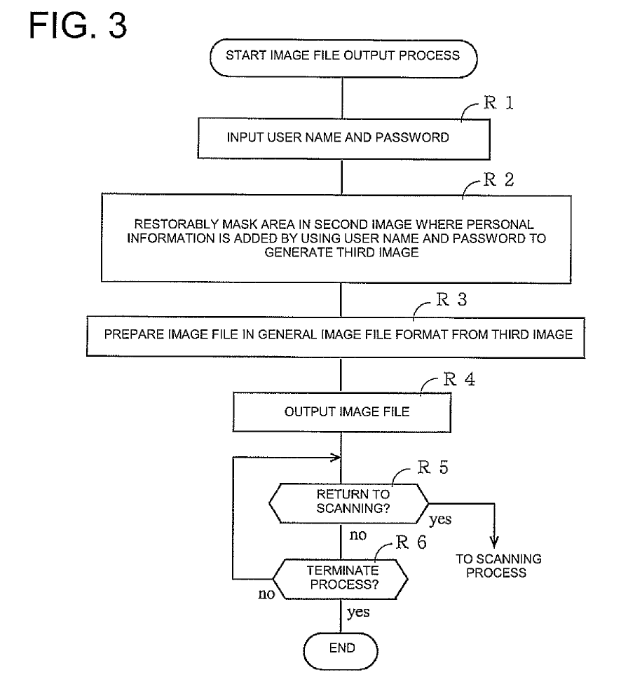

In Step S5, if the operator issues an instruction of shifting to an image file output process, the flow shifts to the image file output process shown in FIG. 3. If not, the flow proceeds to Step 6.

In Step S6, if the operator issues an instruction of terminating the process, the process is terminated. If not, the flow returns to Step S2.

FIG. 3 is a flowchart showing procedures of the image file output process according to the first embodiment.

In Step R1, the operator inputs a user name and a password with the operation unit 5.

In Step R2, the third-image generating unit 3d restorably masks, in a human-unreadable manner, an area in the second image G2 where the personal information is added by using the user name and the password so as to generate the third image G3 as shown in FIG. 7.

In Step R3, the image file input/output unit 3e prepares an image file in a general image file format such as a JPEG format, a PIC format and an acrobat format from the third image G3.

In Step R4, the image file input/output unit 3e outputs the image file to the recording unit 6. The personal information is hidden in the image file. Accordingly, even if the image file is disclosed in, for example, a presentation of an academic conference, the personal information is protected. Further, even if a personal computer whose hard disk has the image file stored is stolen, or a portable medium on which the image file is stored is flowed out, the personal information is protected.

In Step R5, if the operator issues an instruction of shifting to the scanning process, the flow shifts to the scanning process shown in FIG. 2. If not, the flow proceeds to Step R6.

In Step R6, if the operator issues an instruction of terminating the process, the process is terminated. If not, the flow returns to Step R5.

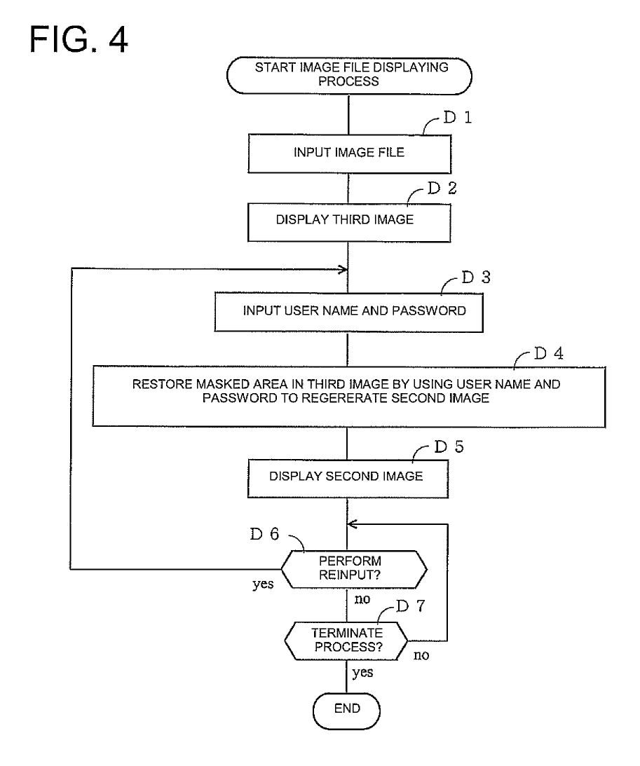

FIG. 4 is a flowchart showing procedures of an image file displaying process.

The image file displaying process is started by an instruction of the operator.

In Step D1, the image file input/output unit 3e inputs the image file from the recording unit 6.

In Step D2, the second-image regenerating unit 3f generates the third image G3 from the input image file, and the image displaying unit 4 displays the third image G3.

In Step D3, the operator inputs the user name and the password with the operation unit 5.

In Step D4, the second-image regenerating unit 3f performs a reverse masking process for the masked area in the third image G3 by using the user name and the password. If the user name and the password are correct, the masked area is correctly restored and the original second image G2 is regenerated. On the other hand, if the user name and the password are incorrect, the area in a human-unreadable manner still exists in the regenerated second image.

In Step D5, the regenerated second image is displayed. Viewing the displayed second image helps to recognize whether or not the input user name and password were correct.

In Step D6, if the operator inputs an instruction of reinputting a user name and a password, the flow returns to Step D3. If not, the flow proceeds to Step D7.

In Step D7, if the operator issues an instruction of terminating the process, the process is terminated. If not, the flow returns to Step D6.

According to the ultrasound diagnostic apparatus 100 of the first embodiment, the following advantages can be obtained. It is possible for an operator to immediately view the second image G2 that is a medical image with personal information in a human-readable manner. Moreover, because the image file with personal information in a human-unreadable manner is output, it is possible to prevent leak of personal information. Further, because the image file is in a general image file format, it is easily accessible to anyone, and it is convenient in a presentation of an academic conference or in a WEB posting.

It should be noted that the second image G2 may be output, as it is, to a system such as a DICOM (Digital Imaging and Communications in Medicine) which originally prevents leak of personal information.

FIG. 8 is a diagram for explaining a configuration of a medical image file output apparatus 200 according to a second embodiment.

The medical image file output apparatus 200 includes a control unit 11, an image displaying unit 12 which displays a second image and the like, an operation unit 13 with which an operator inputs personal information or an instruction, and a recording unit 14 which records or reads an image file on/from a hard disk or a portable medium.

The control unit 11 includes a second-image input unit 11c which inputs a second image G2 output from a medical image diagnostic apparatus A that outputs a medical image (hereinafter, assumed as the second image G2 of FIG. 6) with personal information in a human-readable manner, a third-image generating unit 11d which generates an image (hereinafter, assumed as the third image G3 of FIG. 7) obtained by converting an area in the second image G2 where the personal information is added, into a human-unreadable manner, an image file input/output unit 11e which prepares an image file in a general image file format from the third image G3 for output to the recording unit 14 or inputs the image file in a general image file format from the recording unit 14, and a second-image regenerating unit 11f which regenerates the third image G3 from the input image file and reconverts the area in the third image G3 converted into a human-unreadable manner, into a human-readable manner to regenerate the second image G2.

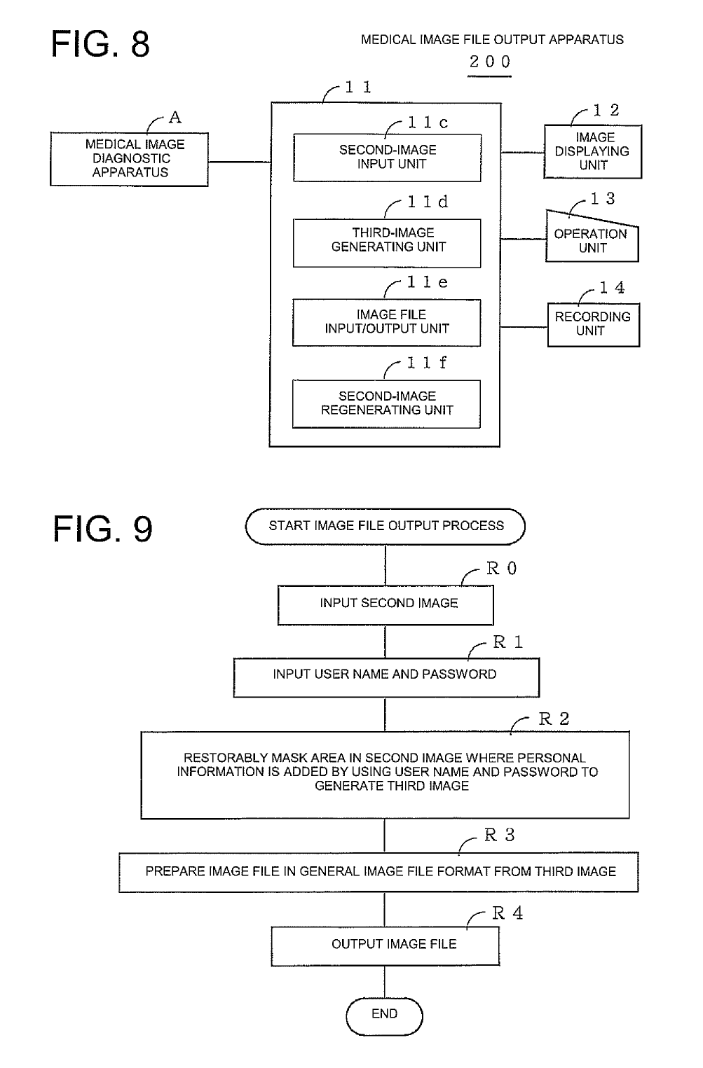

FIG. 9 is a flowchart showing procedures of an image file output process performed by the medical image file output apparatus 200.

In Step R0, the second image G2 output from the medical image diagnostic apparatus A is input.

In Step R1, the operator inputs a user name and a password with the operation unit 13.

In Step R2, the third-image generating unit 11d restorably masks, in a human-unreadable manner, an area in the second image G2 where the personal information is added by using the user name and the password so as to generate the third image G3.

In Step R3, the image file input/output unit 11e prepares an image file in a general image file format from the third image G3.

In Step R4, the image file input/output unit 11e outputs the image file to the recording unit 14. Then, the flow is terminated.

The personal information is hidden in the third image G3. Accordingly, even if the third image G3 is disclosed in, for example, a presentation of an academic conference, the personal information is protected. Further, even if a personal computer whose hard disk has the third image G3 stored is stolen, or a portable medium on which the third image G3 is stored is flowed out, the personal information is protected.

Processing procedures of reading the image file from the recording unit 14 for display are the same as those in FIG. 4.

According to the medical image file output apparatus 200 of the second embodiment, the following advantages can be obtained. It is possible to output an image file which is prepared by preventing leak of personal information for the second image G2 that is a medical image with personal information in a human-readable manner prepared by the conventional medical image diagnostic apparatus A. Moreover, because the image file with personal information in a human-unreadable manner is output, it is possible to prevent leak of personal information. Further, because the image file is in a general image file format, it is easily accessible to anyone, and it is convenient in a presentation of an academic conference or in a WEB posting.

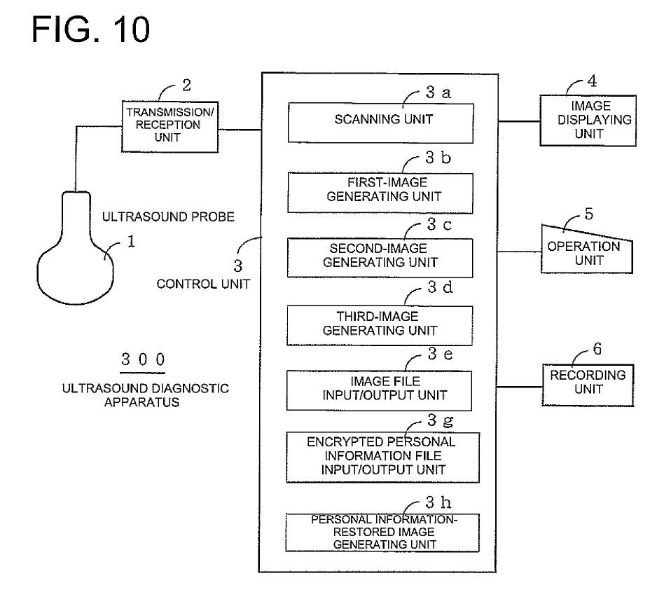

FIG. 10 is a diagram for explaining a configuration of an ultrasound diagnostic apparatus 300 according to a third embodiment.

The ultrasound diagnostic apparatus 300 includes an ultrasound probe 1, a transmission/reception unit 2 which drives the ultrasound probe 1 to scan the inside of a subject with an ultrasound beam, a control unit 3, an image displaying unit 4 which displays a second image to be described later, and the like, an operation unit 5 with which an operator inputs personal information or an instruction, and a recording unit 6 which records or reads an image file to be described later on/from a hard disk or a portable medium.

The control unit 3 includes a scanning unit 3a which controls scanning, a first-image generating unit 3b which generates a first image from data obtained by scanning, a second-image generating unit 3c which generates a second image obtained by adding personal information in a human-readable manner to the first image, a third-image generating unit 3d which extracts and encrypts the personal information from an area in the second image where the personal information is added to generate an encrypted personal information file and generates a third image obtained by converting the area into a human-unreadable manner, an image file input/output unit 3e which prepares an image file in a general image file format from the third image for output to the recording unit 6 or inputs the image file in a general image file format from the recording unit 6, an encrypted personal information file input/output unit 3g which outputs or inputs the encrypted personal information file to/from the recording unit 6, and a personal information-restored image generating unit 3h which regenerates the third image from the input image file, restores the personal information from the input encrypted personal information file to be added to the third image, and generates a personal information-restored image.

Processing procedures of scanning the subject is the same as those in FIG. 2.

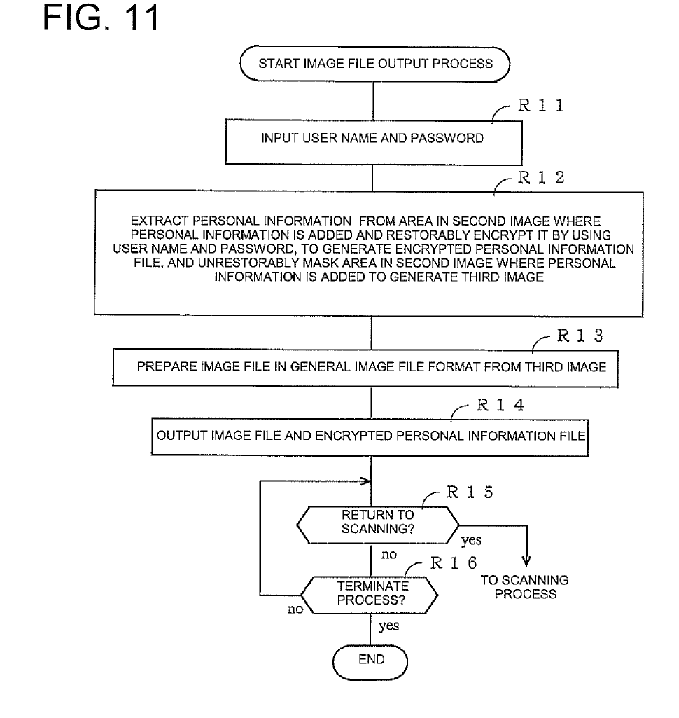

FIG. 11 is a flowchart showing procedures of an image file output process according to the third embodiment.

In Step R11, the operator inputs a user name and a password with the operation unit 5.

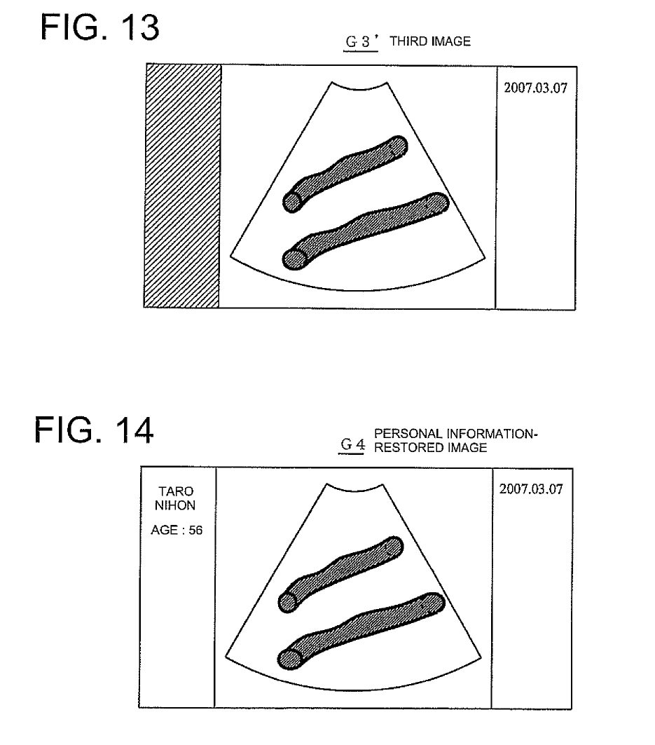

In Step R12, the third image generating unit 3d extracts the personal information from the area in the second image (hereinafter, assumed as the second image G2 of FIG. 6) where the personal information is added, restorably encrypts the same by using the user name and the password, and generates the encrypted personal information file. Further, the third image generating unit 3d unrestorably masks, in a human-unreadable manner, the area in the second image G2 where the personal information is added so as to generate a third image G3′ as shown in FIG. 13.

In Step R13, the image file input/output unit 3e prepares an image file in a general image file format such as a JPEG format, a PIC format, and an acrobat format from the third image G3′.

In Step R14, the image file input/output unit 3e outputs the image file to the recording unit 6. The encrypted personal information file input/output unit 3g outputs the encrypted personal information file to the recording unit 6. The personal information is deleted in the image file. Accordingly, even if the image file is disclosed in, for example, a presentation of an academic conference, the personal information is protected. Further, even if a personal computer whose hard disk has the image file and the encrypted personal information file stored is stolen, or a portable medium on which the image file and the encrypted personal information file are stored is flowed out, the personal information is protected.

In Step R15, if the operator issues an instruction of shifting to the scanning process, the flow shifts to the scanning process. If not, the flow proceeds to Step R16.

In Step R16, if the operator issues an instruction of terminating the process, the process is terminated. If not, the flow returns to Step R15.

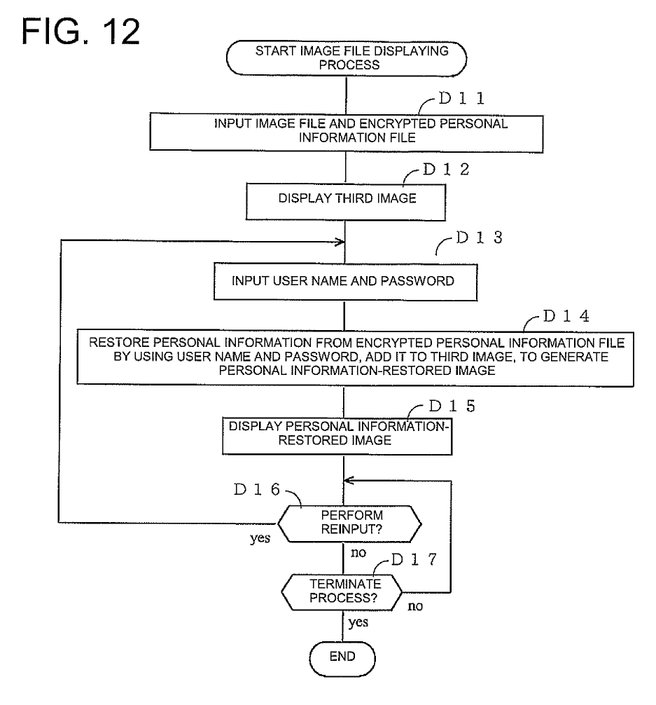

FIG. 12 is a flowchart showing procedures of an image file displaying process.

The image file displaying process is started by an instruction of the operator.

In Step D11, the image file input/output unit 3e inputs the image file from the recording unit 6. Further, the encrypted personal information file input/output unit 3g inputs the encrypted personal information file from the recording unit 6.

In Step D12, the personal information-restored image generating unit 3h generates the third image G3′ from the input image file, and the image displaying unit 4 displays the third image G3′.

In Step D13, the operator inputs the user name and the password with the operation unit 5.

In Step D14, the personal information-restored image generating unit 3h restores the personal information from the input encrypted personal information file by using the user name and the password, and adds the same to the third image G3′ to generate a personal information-restored image G4 as shown in FIG. 14. If the user name and the password are correct, the correctly-restored personal information is added. On the other hand, if the user name and the password are incorrect, random information is added.

In Step D15, the generated personal information-restored image is displayed. Viewing the displayed personal information-restored image helps to recognize whether or not the input user name and password were correct.

In Step D16, if the operator inputs an instruction of reinputting a user name and a password, the flow returns to Step D13. If not, the flow proceeds to Step D17.

In Step D17, if the operator issues an instruction of terminating the process, the process is terminated. If not, the flow returns to Step D16.

According to the ultrasound diagnostic apparatus 300 of the third embodiment, the following advantages can be obtained. It is possible for an operator to immediately view the second image G2 that is a medical image with personal information in a human-readable manner. Moreover, because the image file with personal information in a human-unreadable manner is output, it is possible to prevent leak of personal information. Further, because the image file is in a general image file format, it is easily accessible to anyone, and it is convenient in a presentation of an academic conference or in a WEB posting.

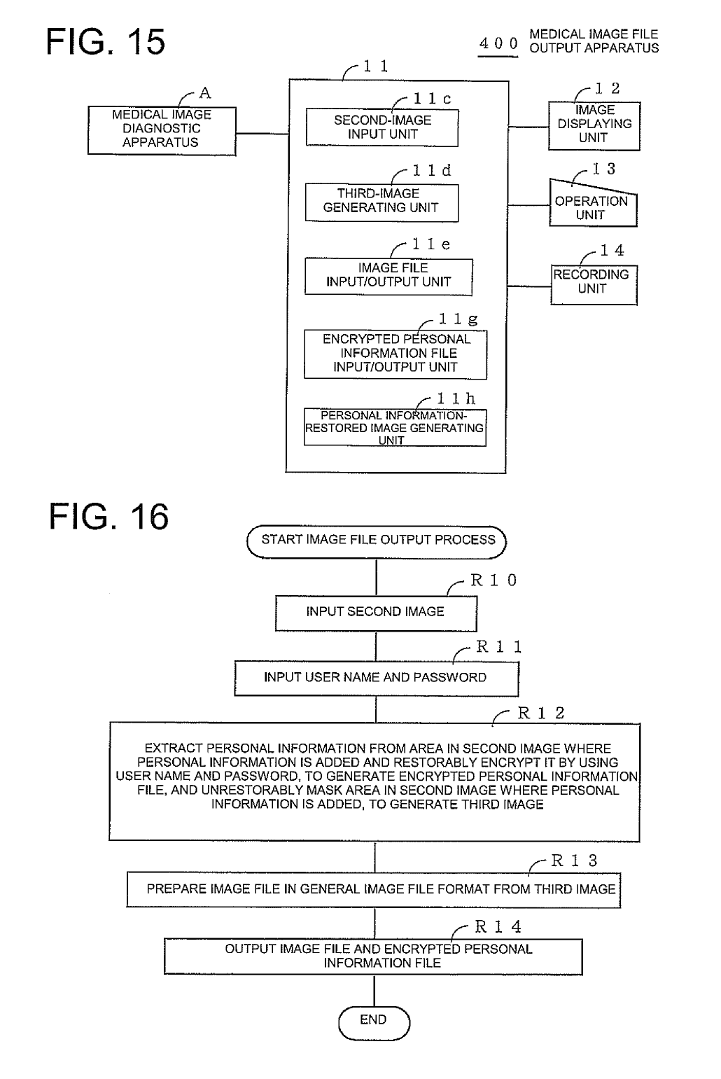

FIG. 15 is a diagram for explaining a configuration of a medical image file output apparatus 400 according to a fourth embodiment.

The medical image file output apparatus 400 includes a control unit 11, an image displaying unit 12 which displays a second image and the like, an operation unit 13 with which an operator inputs personal information or an instruction, and a recording unit 14 which records or reads an image file on/from a hard disk or a portable medium.

The control unit 11 includes a second-image input unit 11c which inputs a second image G2 output from a medical image diagnostic apparatus A that outputs a medical image (hereinafter, assumed as the second image G2 of FIG. 6) with personal information in a human-readable manner, a third-image generating unit 11d which extracts and encrypts the personal information from an area in the second image G2 where the personal information is added to generate an encrypted personal information file and generates an image (hereinafter, assumed as the third image G3′ of FIG. 13) by converting the area into a human-unreadable manner, an image file input/output unit 11e which prepares an image file in a general image file format from the third image G3′ for output to the recording unit 14 or inputs the image file in a general image file format from the recording unit 14, an encrypted personal information file input/output unit 11g which outputs or inputs the encrypted personal information file to/from the recording unit 14, and a personal information-restored image generating unit 11h which regenerates the third image G3′ from the input image file, restores the personal information from the input encrypted personal information file to be added to the third image G3′, and generates a personal information-restored image (hereinafter, assumed as the personal information-restored image G4 of FIG. 14).

FIG. 16 is a flowchart showing procedures of an image file output process performed by the medical image file output apparatus 400.

In Step R10, the second image G2 output from the medical image diagnostic apparatus A is input.

In Step R11, the operator inputs a user name and a password with the operation unit 13.

In Step R12, the personal information is extracted from the area in the second image G2 where the personal information is added, and is restorably encrypted by using the user name and the password to generate the encrypted personal information file. Further, the area in the second image G2 where the personal information is added is unrestorably masked in a human-unreadable manner to generate a third image G3′ as shown in FIG. 13.

In Step R13, the image file input/output unit 11e prepares an image file in a general image file format such as a JPEG format, a PIC format, and an acrobat format from the third image G3′.

In Step R14, the image file input/output unit 11e outputs the image file to the recording unit 14. The encrypted personal information file input/output unit 11g outputs the encrypted personal information file to the recording unit 14. Then, the process is terminated.

The personal information is deleted in the third image G3′. Accordingly, even if the third image G3′ is disclosed in, for example, a presentation of an academic conference, the personal information is protected. Further, even if a personal computer whose hard disk has the third image G3′ and the encrypted personal information file stored is stolen, or a portable medium on which the third image G3′ and the encrypted personal information file are stored is flowed out, the personal information is protected.

Processing procedures of reading the image file from the recording unit 14 for display are the same as those in FIG. 12.

According to the medical image file output apparatus 400 of the fourth embodiment, the following advantages can be obtained. It is possible to output an image file which is prepared by preventing leak of personal information for the second image G2 that is a medical image with personal information in a human-readable manner prepared by the conventional medical image diagnostic apparatus A. Moreover, because the image file with personal information in a human-unreadable manner is output, it is possible to prevent leak of personal information. Further, because the image file is in a general image file format, it is easily accessible to anyone, and it is convenient in a presentation of an academic conference or in a WEB posting.

The invention can be applied to a medical image diagnostic apparatus such as an X-ray CT scanner and an MRI machine.

Many widely different embodiments of the invention may be configured without departing from the spirit and the scope of the present invention. It should be understood that the present invention is not limited to the specific embodiments described in the specification, except as defined in the appended claims.

1. A medical image file output apparatus, comprising:
a second-image input device configured to input a second image obtained by adding personal information in a human-readable manner to a first image obtained by scanning a subject;
a third-image generating device configured to convert an area in the second image where the personal information is added, into a human-unreadable manner to generate a third image; and
an image file output device configured to prepare an image file in a general image file format from the third image for output.

2. The medical image file output apparatus according to claim 1, wherein:
the general image file format is any one of a JPEG format, a PIC format, and an acrobat format.

3. The medical image file output apparatus according to claim 1, wherein:
the human-unreadable manner is a manner which can be reconverted into a human-readable manner.

4. The medical image file output apparatus according to claim 2, wherein:
the human-unreadable manner is a manner which can be reconverted into a human-readable manner.

5. The medical image file output apparatus according to claim 3, wherein:
the third-image generating device is configured to require a user to input a user name and a password prior to generation of the third image.

6. The medical image file output apparatus according to claim 1, wherein:
the human-unreadable manner is a manner which can not be reconverted into a human-readable manner, the third-image generating device is configured to read and encrypt the personal information in the second image to prepare an encrypted personal information file, said medical image file output apparatus further comprising an encrypted personal information file output device configured to output the encrypted personal information file.

7. The medical image file output apparatus according to claim 2, wherein:
the human-unreadable manner is a manner which can not be reconverted into a human-readable manner, the third-image generating device is configured to read and encrypt the personal information in the second image to prepare an encrypted personal information file, said medical image file output apparatus further comprising an encrypted personal information file output device configured to output the encrypted personal information file.

8. The medical image file output apparatus according to claim 6, wherein:
the third-image generating device of is configured to require a user to input a user name and a password prior to generation of the encrypted personal information file.

9. The medical image file output apparatus according to claim 1, wherein:
the image file output device is configured to output the image file to at least one of a hard disk and a portable medium.

10. A medical image diagnostic apparatus, comprising:
a scanning device configured to scan a subject;
a first-image generating device configured to generate a first image from data obtained by scanning;
a second-image generating device configured to generate a second image by adding personal information in a human-readable manner to the first image;
an image displaying device configured to display the second image;
a third-image generating device configured to convert an area in the second image where the personal information is added, into a human-unreadable manner to generate a third image; and
an image file output device configured to prepare an image file in a general image file format from the third image for output.

11. The medical image diagnostic apparatus according to claim 10, wherein:
the general image file format is any one of a JPEG format, a PIC format, and an acrobat format.

12. The medical image diagnostic apparatus according to claim 10, wherein:
the human-unreadable manner is a manner which can be reconverted into a human-readable manner.

13. The medical image diagnostic apparatus according to claim 12, comprising:
an image file input device configured to input the image file; and
an image regenerating device configured to regenerate the third image from the image file, the image regenerating device further configured to reconvert the area in the third image converted into the human-unreadable manners into a human-readable manner to regenerate the second image.

14. The medical image diagnostic apparatus according to claim 13, wherein:
the third-image generating device is configured to require inputting of a user name and a password prior to generation of the third image, and the image regenerating device is configured to require inputting of the user name and the password prior to regeneration of the second image.

15. The medical image diagnostic apparatus according to claim 10, wherein:
the human-unreadable manner is a manner which can not be reconverted into a human-readable manner, the third-image generating device is configured to read and encrypt the personal information in the second image to prepare an encrypted personal information file, said medical image diagnostic apparatus further comprises an encrypted personal information file output device configured to output the encrypted personal information file.

16. The medical image diagnostic apparatus according to claim 15, further comprising:
an encrypted personal information file input device configured to input the encrypted personal information file;
a personal information restoring device configured to restore the personal information from the encrypted personal information file;
an image file input device configured to input the image file; and
a personal information-restored image generating device configured to regenerate the third image from the image file, the personal information-restored image device further configured to embed the restored personal information into the area in the third image which is converted into the human-unreadable manner.

17. The medical image diagnostic apparatus according to claim 16, wherein:
the third-image generating device is configured to require a user to input a user name and a password prior to generation of the encrypted personal information file, and the personal information restoring device is configured to require the user to input the user name and the password prior to restoration of the personal information.

18. The medical image diagnostic apparatus according to claim 16, wherein:
the third-image generating device is configured to require a user to input a user name and a password prior to generation of the encrypted personal information file, and the personal information restoring device is configured to require the user to input the user name and the password prior to embedding of the restored personal information.

19. The medical image diagnostic apparatus according to claim 10, wherein:
the image file output device is configured to output the image file to at least one of a hard disk and a portable medium.

20. A method for outputting a medical image file, comprising:
inputting a second image obtained by adding personal information in a human-readable manner to a first image obtained by scanning a subject;
converting an area in the second image where the personal information is added, into a human-unreadable manner to generate a third image; and
preparing an image file in a general image file format from the third image for output.
